(19) United States
(12) Patent Application Publication
(10) Pub. No.: US 2024/0392824 A1
(43) Pub. Date: Nov. 28, 2024

(54) EXTENDABLE MAGAZINE, FILLED MAGAZINE AND USE

(71) Applicant: Hilti Aktiengesellschaft, Schaan (LI)

(72) Inventors: Tobias KURZ, Trübbach (CH); Sasha LUKIC, Buchs (CH); Gerard BAUMGARTNER, Luzern (CH); Marius SPRENGER, Haag (CH); Michael ZILTENER, Siebnen (CH)

(21) Appl. No.: 18/696,863

(22) PCT Filed: Nov. 3, 2022
(86) PCT No.: PCT/EP2022/080640

§ 371 Date: Mar. 28, 2024

(30) Foreign Application Priority Data
Nov. 17, 2021 (EP) 21208694.6

(51) Int. Cl. F16B 27/00

(52) U.S. Cl. CPC F16B 27/00

(57) ABSTRACT

A magazine suitable for receiving at least one fastening means is provided, comprising at least one receiving cell, wherein each receiving cell has a cell frame which has a through-opening, wherein the through-opening extends through the receiving cell. Each receiving cell has a multiplicity of engagement fingers which extend from the cell frame with their free ends into the through-opening, wherein each of the engagement fingers has at least one rib. Furthermore, a filled magazine and the use of the filled magazine is also provided.

The invention is based on a magazine which is suitable for receiving at least one fastening means.

Often, structural elements, for example installation elements, need to be fastened to walls, ceilings or floors of a building or the like by way of fastening means. Since a large number of such fastening means are required for fastening purposes, use is made of magazines. These make a plurality of the fastening means available to the user in a simple manner.

A strip-form screw magazine, for example, which can be used for fastening means such as screws, for example, is known from DE10162635 A1.

Some fastening means have a collar. Together with a head of the fastening means, such a fastening means has a comparatively high weight. The weight is distributed particularly unevenly along the length of the fastening means. Depending on the position of the magazine, there may therefore be a risk of the fastening means falling out of the magazine.

Therefore, the object of the present invention is to provide a magazine which allows more secure storage of fastening means having collars in magazines.

The object is achieved by a magazine suitable for receiving at least one fastening means, wherein the magazine comprises at least one receiving cell, wherein each receiving cell has a cell frame which has a through-opening, wherein the through-opening extends through the receiving cell, wherein each receiving cell has a multiplicity of engagement fingers which extend from the cell frame with their free ends into the through-opening, wherein each of the engagement fingers has at least one rib. A fastening means having a collar can be introduced into the through-opening along an insertion direction. The insertion direction may extend perpendicularly or substantially perpendicularly to a plane defined by the respective cell frame. “Substantially” may correspond to a deviation from the perpendicular of for example at most 10 degrees, in particular at most 5 degrees.

It is thus possible to introduce several fastening means successively into the same receiving cell and in each case subsequently remove them therefrom again. The magazine can thus be used multiple times.

One or more of the engagement fingers can, in particular by way of their ribs, grip the fastening means at its collar and/or retain it in the magazine.

An engagement finger may be understood to be an elongate portion, projecting from the cell frame, of the cell frame. The engagement finger may also be a part formed separately from the cell frame. The engagement finger may have a free end.

The rib may project laterally from the respective engagement finger. “Laterally” may be understood to be a direction in a perpendicular plane or in a plane at least substantially perpendicular to the insertion direction.

At least one engagement finger of a receiving cell may have at least one two ribs. The ribs may be formed at different heights along the insertion direction. Then, the engagement finger can at least partially enclose the collar simultaneously at several points, for example at a top side and at an underside.

The engagement finger may be elastically deformable. Thus, different types of fastening means, for example having different collar sizes, can be held in the same magazine.

In particular, the engagement finger may have a higher spring constant along the insertion direction than perpendicularly to the insertion direction. It may, at least in one region, have an asymmetric cross section.

When the fastening means is introduced into the through-opening, it can come into contact, for example by way of its collar, with the engagement finger. In this case, upon such contact, the fastening means can press on the engagement finger. The latter can be designed to pivot outward, in particular out of the through-opening and/or toward the cell frame, as a result of the pressure. As a result of the different, direction-dependent spring constants of the engagement finger, the engagement finger can in this case pivot at least substantially laterally and preferably not or only slightly along the insertion direction.

The pivoting can be controlled precisely when at least one engagement finger of a receiving cell has a control contour. The control contour can be designed such that, upon pressure on the control contour along the insertion direction, the engagement finger pivots out of the through-opening. In this case, “pivot out” can mean that the engagement finger leaves the through-opening. Alternatively or additionally, it can also mean that, although the engagement finger remains in the region of the through-opening, it moves away from a center of the through-opening, for example toward the cell frame, as a result of the pressure.

Thus, as a result of the introduction of the fastening means, the through-opening can be opened. The fastening means can pass, in particular with its collar, between the engagement fingers. The engagement fingers can then hold the fastening means, in particular by way of their ribs. The engagement fingers can in particular be designed such that the collar is locked in place therein, in particular between the ribs.

Two adjacent receiving cells of the magazine can be connected together via a connecting portion. The connecting portion may have a low spring constant.

In particular, the connecting portion can have a lower spring constant than an, in particular adjoining, receiving cell. Thus, the magazine may be particularly flexible in the region of the connecting portion. Overall, a flexibly deformable magazine can thus be formed. The magazine may be for example windable.

In order for it to be possible to interlink several magazines, the magazine may have at least one connector. The connector may be designed for connecting to a further magazine.

In particular, the connector may be in the form of a symmetric connector. In other words, it may be configured such that it is connectable to, for example able to be plugged together with, a second connector of the same type.

Alternatively, the connector may also be in the form of an asymmetric connector. In particular, there may be a male connector and a female connector. For example, the female connector may have a socket portion. The male connector may have a plug portion. The plug portion may be congruent with the socket portion.

The magazine may as a whole have at least one female connector and at least one male connector that is congruent with the female connector. Thus, a plurality of magazines can be connected in that respective male portions are successively connected to, in particular plugged together with, respective female portions.

In order to prevent accidental slipping out, at least one of the connectors may have a latching mechanism or at least a partial latching mechanism. One or more of the engagement fingers may also together form a latching mechanism. A partial latching mechanism may be understood as meaning that the connector has a structure which is designed to connect by latching to another connector, not necessarily of the same type, of another magazine.

Experience has shown that waste materials on construction sites are not always disposed of properly. Therefore, it is desirable for any waste materials to be designed to be environmentally harmless. Therefore, it is beneficial when the magazine is made from a biodegradable material.

A material may for example be considered to be biodegradable when 90 percent of the material is biologically broken down in an aqueous medium within 180 days. It is alternatively or additionally also conceivable for a material to be considered biodegradable when it complies with the applicable compostability and/or biodegradability standard for this material.

Such a material may comprises for example a natural fiber. It is also conceivable for example for the material to comprise wood. Alternatively or additionally, it may also comprise a grass. For example, the biodegradable material may comprise, paper, cardboard, hemp and/or bamboo. It may also comprise a biodegradable plastic.

Thus, environmental damage can be avoided even if a user of the magazine does not dispose of it properly after use.

It is particularly advantageous, in particular for this case, when the magazine is entirely biodegradable. In this case, “entirely” may be restricted to a main component of the magazine. For example the term “entirely biodegradable” may also cover a magazine which has very small quantities, for example less than 5 percent by weight, in particular less than 1 percent by weight, particularly preferably less than 1 part per thousand by weight, of substances that are not biodegradable. Such substances may be for example color pigments from lettering or the like on the magazine. However, it is also particularly preferred for lettering or the like to likewise be made from biodegradable materials.

The magazine may be particularly easy to handle when it is in the form of a strip.

In order for it to be possible for example to remove particular numbers of fastening means from the magazine in one piece, the magazine may have a perforation and/or a constriction at at least one point. Along the perforation and/or constriction, the magazine may be divided into several parts.

In order for it to be possible to use the magazine easily with a power tool, for example a hand-held power tool or a construction robot, the magazine may have a pattern of holes and/or a guide slot.

The scope of the invention also covers a filled magazine. The filled magazine comprises a magazine of the above-described type. The magazine is filled with at least one fastening means which has a collar. In the case of the at least one fastening means, the collar of the fastening means can be held by at least one engagement finger.

Preferably, the filled magazine has a multiplicity, for example at least 5, 10 or 20, fastening means.

The fastening means may be for example a screw anchor. Alternatively or additionally, it may also be a nail. For example, it may be a concrete anchor, for example a concrete screw.

It is also conceivable for the fastening means to be designed to fix insulation materials. In particular, it may be in the form of an insulation anchor having a collar.

The scope of the invention also covers the use of a filled magazine of the above-described type by a construction robot to set a fastening means in a ceiling and/or a wall on a construction site. The construction site may be and/or comprise for example a building construction side and/or a civil engineering construction site.

In ceilings and walls, it is particularly difficult to set a fastening means. Thus, it is often not possible to readily take a fastening means, for example a concrete anchor, to the intended location in order for it to remain there until the final setting operation. For example, a concrete anchor loosely plugged into a drilled hole located in a ceiling will very probably drop out of the drilled hole.

The construction robot may have a power tool, for example a setting tool for setting the fastening means. It may have a manipulator. The power tool may be arranged on the manipulator. The manipulator may be in the form for example of a multi-axis arm. It may also have a lifting device. The manipulator may have at least three degrees of freedom, for example at least six degrees of freedom. In particular, the construction robot can then be designed to carry out construction work, in particular to set the fastening means, in the ceiling and/or in the wall.

The magazine may be arrangeable on the power tool. The power tool may, in particular in cooperation with the manipulator, be designed to successively remove fastening elements from the magazine and to respectively set them, in particular in the ceiling and/or in the wall.

Since the fastening means can be held securely in the magazine regardless of the position thereof, and therefore do not unintentionally fall out, the power tool can set the fastening means in virtually any desired positions and/or directions, in particular horizontally and/or vertically. The power tool can be repositioned very quickly without fastening means falling out of the magazine as a result of the accelerations that occur. Thus, a high setting frequency can be achieved at a construction site. In addition, the reliability of the setting operations can be enhanced by the use of the magazine. This is important in particular when construction robots are used and in this case in particular for achieving as high a degree of autonomy as possible.

Further features and advantages of the invention emerge from the following detailed description of exemplary embodiments of the invention, with reference to the figures of the drawing, which shows details essential to the invention, and from the claims. The features shown there are not necessarily to be understood as true to scale and are shown in such a way that the special features according to the invention can be made clearly visible. The various features can be implemented individually in their own right or collectively in any combinations in variants of the invention.

Exemplary embodiments of the invention are shown in the schematic drawing and explained in more detail in the following description.

In the drawing:

FIG. 1 shows a perspective illustration of a filled magazine:

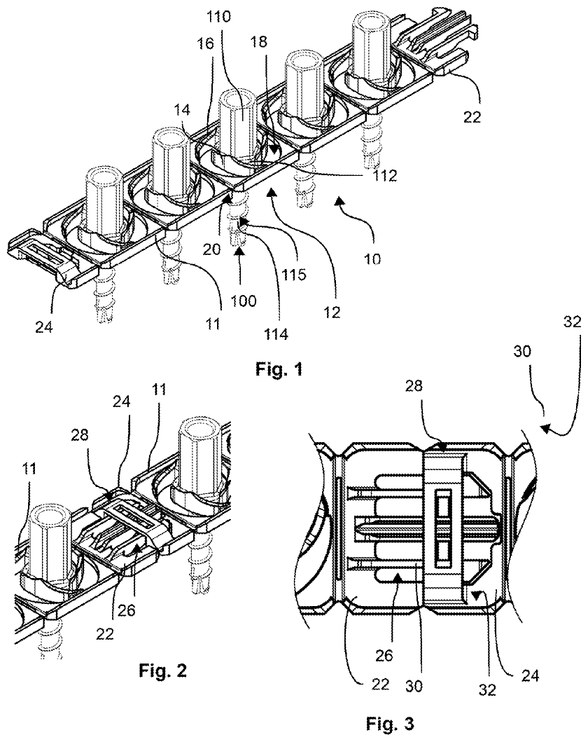

FIGS. 2 and 3 show perspective illustrations of connectors:

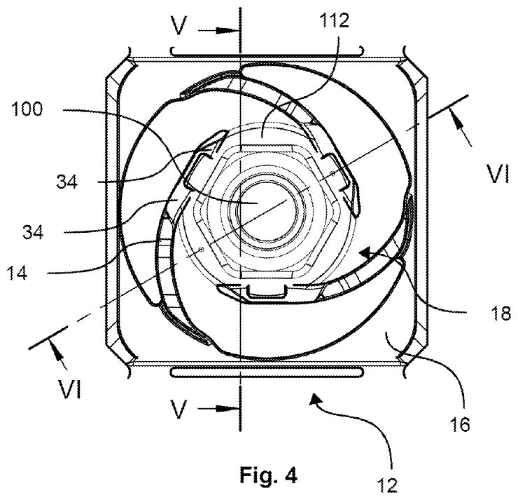

FIG. 4 shows a view from above of a receiving cell with a fastening means:

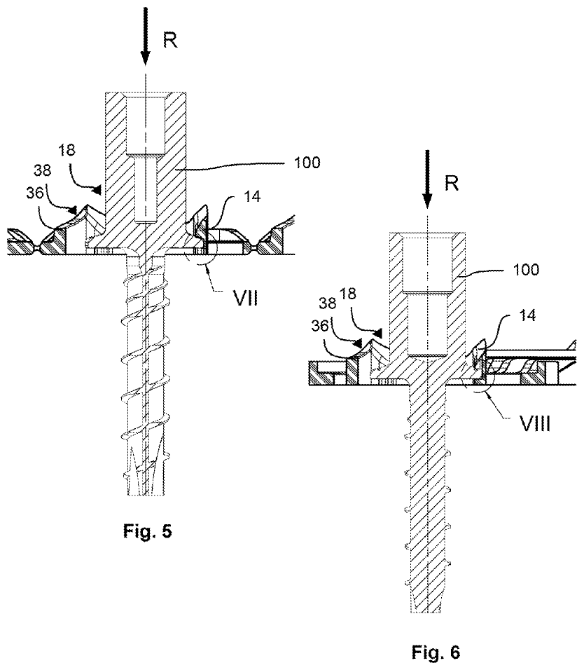

FIGS. 5 and 6 show cross-sectional view of the receiving cell with the fastening means according to FIG. 4:

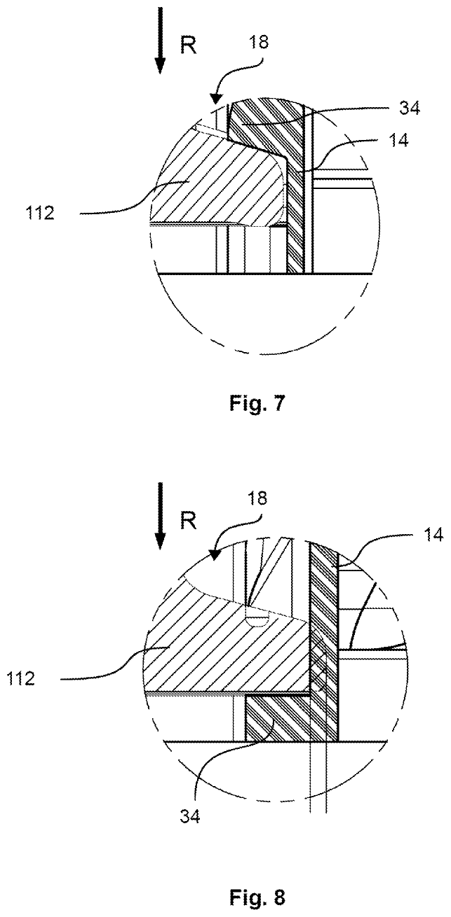

FIGS. 7 and 8 show enlarged detail views of the cross-sectional views in FIGS. 5 and 6:

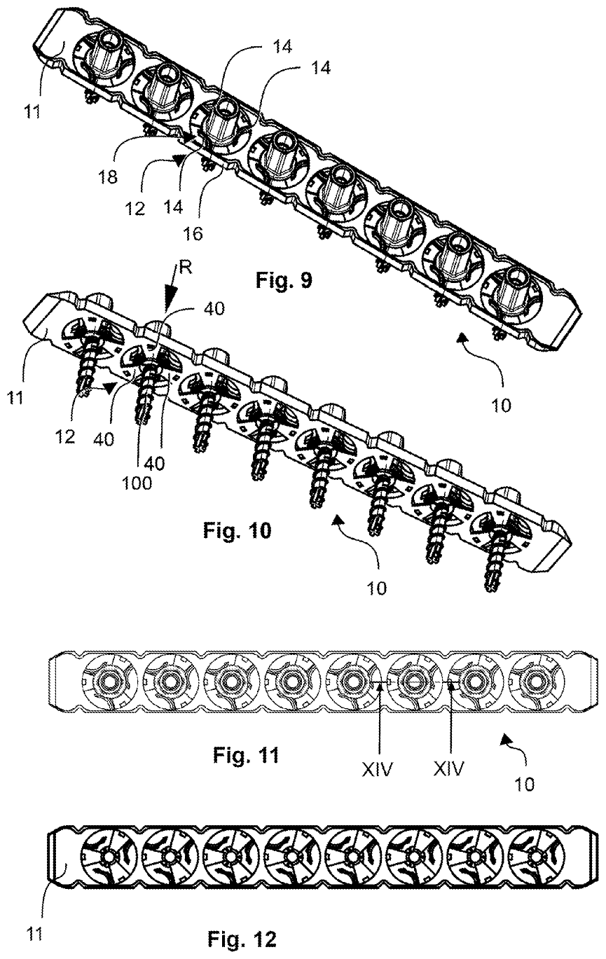

FIGS. 9 to 11 show perspective illustrations and a plan view of a further filled magazine:

FIG. 12 shows a plan view of the magazine in FIGS. 9 to 11:

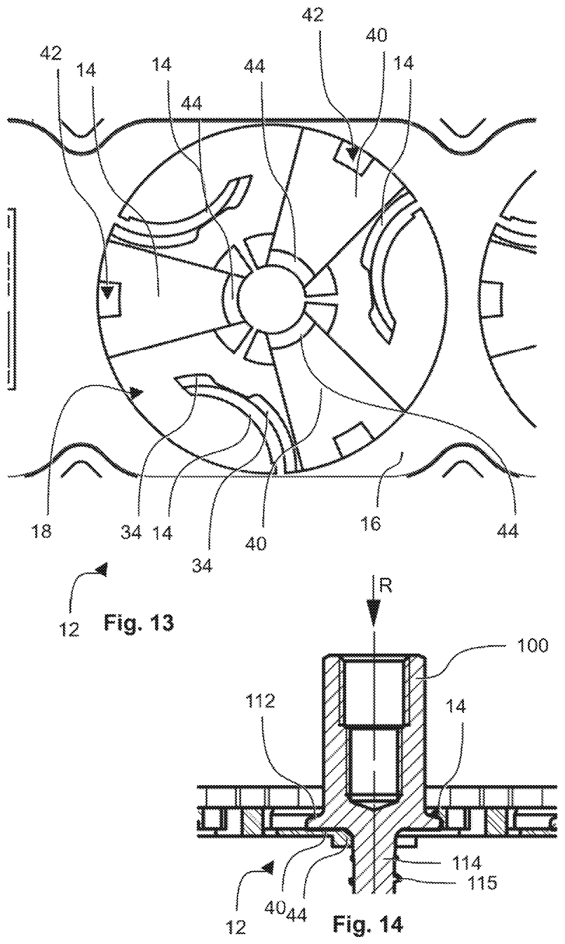

FIG. 13 shows an enlarged detail view of a receiving cell of the magazine in FIG. 12; and

FIG. 14 shows a longitudinal section through a receiving cell of the filled magazine in FIG. 11.

In order to make it easier to understand the invention, the same reference signs are used in each case for identical or functionally corresponding elements in the following description of the figures. To simplify the illustration, as a rule, when there are several elements of the same type in the individual figures, only one of the elements is provided with a reference sign in each case.

FIG. 1 shows a perspective illustration of a filled magazine 10.

The filled magazine 10 has a magazine 11. The magazine 11 is configured as a strip. It is therefore in the form of a strip.

A plurality of fastening means 100 are received in the magazine 11. To this end, the magazine has a plurality of receiving cells 12.

Each of the receiving cells 12 has a plurality of, in particular three, engagement fingers 14. The engagement fingers 14 are each located on a cell frame 16 of the respective receiving cell 12. In their interior, the cell frames 16 each have through-openings 18.

Preferably, the magazine is manufactured from an entirely biodegradable material, for example from a biodegradable plastic. Thus, the engagement fingers 14 can furthermore be elastically deformable. In addition, environmental damage caused by improper disposal of the magazine 11 can be avoided. The release of microplastics into the environment can also be counteracted.

The fastening means 100 each have a head 110, a collar 112 and a shank 114.

In this exemplary embodiment, the fastening means 100 with the collar 112 is embodied as a screw anchor. To this end, it has a thread 115. The fastening means 100 may be for example a concrete screw.

Adjoining the receiving cells 12, there are connecting portions 20. The connecting portions 20 are flexurally elastic. They each have comparatively low spring constants. To this end, they may be for example thinner and/or narrower and/or made from a different material than the remaining regions of the magazine 11.

At its two longitudinal ends, the magazine 11 has respective connectors 22 and 24. The connectors 22, 24 are designed to connect a plurality of magazines 11 of the same type together.

FIGS. 2 and 3 show such connectors 22, 24 in a perspective illustration and in a view from the front.

Two magazines 11, which may have for example a similar, in particular identical, construction, are connected together via the connectors 22, 24.

To this end, the connector 22 is in the form of a male connector. It has a plug portion 26. The connector 24 has a construction complementary to the connector 22 and is in particular in the form of a female connector. To this end, it has a socket portion 28. As is apparent in particular from FIG. 3, the male connector 22 has a plurality of latching tongues 30. The latching tongues 30 of the plug portion 26 can engage behind associated latching portions 32 of the socket portion 28. The connectors 22, 24 thus each form a partial latching mechanism. Together, they form a latching mechanism. By means of the latching mechanism, the connectors 22, 24 are kept against one another in the plugged-together state even under tensile loads or the like.

FIG. 4 shows a view from above of a receiving cell 12 with a cell frame 16 and a fastening element 100.

Three engagement fingers 14 are attached to the cell frame 16. With their free ends, they constrict a central, free region of the through-opening 18. In particular, they engage around the collar 112 of the fastening means 100 by way of ribs 34.

FIG. 5 shows a cross section through the receiving cell 12 along the section line V in FIG. 4, and FIG. 6 shows a cross section along the section line VI in FIG. 4.

It is apparent in each case that the fastening means 100 fits with its collar 112 in the through-opening 18. To this end, it is held in the through-opening 18 by the engagement fingers 14.

Each engagement finger 14 may have a control contour 36. The control contour 36 may be configured such that, upon pressure thereon along an insertion direction R, as may be exerted for example by the fastening means 100 when it is introduced into the through-opening 18, the engagement finger 14 is forced out of the through-opening 18. The insertion direction R corresponds to a direction along which the fastening means 100 is able to be introduced into the through-opening 18.

In particular, the control contour 36 has a slope 38, the surface of which extends obliquely to the insertion direction R.

FIG. 7 and FIG. 8 show enlarged illustrations of the details VII and VIII in FIG. 5 and FIG. 6, respectively.

In this exemplary embodiment, each engagement finger 14 has a plurality of the ribs 34.

The ribs 34 project from the respective engagement finger 14 in particular perpendicularly to the insertion direction R.

As is apparent from comparing FIG. 7 with FIG. 8, the ribs 34 are arranged or formed at different heights along the insertion direction R. Their spacing along the insertion direction R may correspond, at least approximately, to a thickness of the collar 112.

The ribs 34 each extend beyond a peripheral region of the collar 112. The rib 34 shown in FIG. 7 holds the collar 112 on a top side, while the rib 34 shown in FIG. 8 holds the collar 112 on an underside opposite to the top side.

The collar 112 is thus locked in place between the ribs 34.

In order to facilitate pivoting out of the through-opening 18, the engagement finger 14 has a rectangular cross section at least regionally, away from the ribs 34. In particular, it has a higher spring constant in the direction of the insertion direction R than transversely thereto.

A further embodiment of a filled magazine 10 with its magazine 11 is shown in FIGS. 9 to 11 in perspective views and in a plan view.

FIG. 12 shows the associated, unfilled magazine 11, likewise in a plan view.

Unless described otherwise, the magazine 11 and the filled magazine 10 according to FIGS. 9 to 12 can have one or more of the features of the above-described embodiment of the magazine 11 or of the filled magazine 10.

For example, this magazine 11 again has a multiplicity of receiving cells 12, of which, by way of example, one is provided with a reference sign in FIG. 9.

Each receiving cell 12 again has a plurality of, in particular three, engagement fingers 14. The engagement fingers 14 are again each located on a cell frame 16 of the respective receiving cell 12. In their interior, the cell frames 16 again each have through-openings 18.

In this embodiment, each receiving cell 12, as is apparent in particular from FIG. 10, has a plurality of, in particular three, bending tabs 40.

The bending tabs 40 support a fastening means 100 from below, that is to say counter to the insertion direction R.

FIG. 13 shows a plan view of one of the receiving cells 12 in an enlarged illustration.

In the state illustrated in FIG. 13, no fastening means 100 has been fitted in the receiving cell 12 shown (see FIG. 10).

The engagement fingers 14 again have ribs 34, of which for example two ribs 34 have been provided with a reference sign.

The bending tabs 40 project as at least substantially trapezoidal projections from the cell frame 16. The project into the through-opening 18.

In particular adjoining the cell frames 16, cutouts 42 have been made in the bending tabs 40.

The bending tabs 40 are flexurally elastic. On account of the cutouts 42, the bending tabs 40 have a lower effective spring constant in the regions around the cutouts 42. Thus, they can pivot under pressure loading along the insertion direction R (see FIG. 10), that is to say, in FIG. 13, perpendicularly to the plane of the image in FIG. 13. In particular, on pivoting, they can deform predominantly in the regions around the cutouts 42. This can make it easier to remove the fastening means 100 by pushing it through along the insertion direction R, and thus to set the fastening means 100 directly from its receiving cell 12.

At their free ends, the bending tabs 40 have ring segments 44. By way of the ring segments 44, the bending tabs 40 can enclose for example the shank 114 (FIG. 1) of the fastening means 100.

It is apparent that in this embodiment too, the free ends of the engagement fingers 14 can pivot, under corresponding pressure, in the direction of the cell frame 16, in particular laterally.

Thus, it is possible in this embodiment too for collars 112 (see FIG. 8) with different diameters to be held equally by the engagement fingers 14.

FIG. 14 shows a longitudinal section through a receiving cell 12 of the filled magazine in FIG. 11 along the section line XIV-XIV therein.

It is apparent that the collar 112 of the fastening means 100 is bordered on its underside by the bending tabs 40. The ring segments of the latter bear against the shank 114 of the fastening means 100. On the top side, the engagement fingers 14 bear on the collar 112.

The fastening means 100 may be inserted into the receiving cell 12 by being introduced under slight pressure into the receiving cell 12 from the top side O along the insertion direction R. As a result, the engagement fingers 14 pivot and open up a corresponding space for receiving the collar 112, into which the collar 112 ultimately passes. By means of their ribs 34 (see FIG. 13), the engagement fingers 14 then fix the collar 112 in place.

In the meantime, the bending tabs 40 bend at least slightly such that shank 114 with the thread 115 slides along them. Finally, the shank 114 with the thread 115 is located beneath the ring segments 44.

Therefore, to insert the fastening means 100, it is not necessary to rotate the fastening means 100 about its longitudinal axis.

The fastening means is prevented from being pushed completely through the receiving cell 112 inter alia by the bending tabs 40, as long as the pressure remains below a particular threshold value.

Removal can take place by renewed, greater pressure on the fastening means 100 along the insertion direction R. In this case, the bending tabs 40 bend even further, until they have opened wide enough for the collar 112 and the fastening means 100 passes entirely out of the receiving cell 12.

In this case, the cutouts 42 form defined weak points, which ensure a controlled bending behavior or, if required, breaking behavior of the bending tabs 40.

It is thus possible to ensure that, after the setting means 100 has been set, for example in a wall, no residual particles stick to the fastening means 100 and are located for example between the collar 112 and the wall. It is thus also possible to ensure a subsequent proper fit of the fastening means 100, for example in the wall.

### LIST OF REFERENCE SIGNS

10 Filled magazine
11 Magazine
12 Receiving cell
14 Engagement finger
16 Cell frame
18 Through-opening
20 Connecting portion
22 Connector
24 Connector
26 Plug portion
28 Socket portion
30 Latching tongue
32 Latching portion
34 Rib
36 Control contour
38 Slope
40 Bending tab
42 Cutout
44 Ring segment
100 Fastening means
110 Head
112 Collar
114 Shank
115 Thread
R Insertion direction
V Section line
VI Section line
VII Region
VIII Region

1. A magazine suitable for receiving at least one fastening means,
wherein the magazine comprises at least one receiving cell,
wherein each receiving cell has a cell frame which has a through-opening, wherein the through-opening extends through the receiving cell,
wherein each receiving cell has a multiplicity of engagement fingers which extend from the cell frame with free ends of each engagement finger into the through-opening, wherein each of the engagement fingers has at least one rib.

2. The magazine as claimed in claim 1, wherein at least one engagement finger of a receiving cell has at least two ribs.

3. The magazine as claimed in claim 1, wherein at least one engagement finger of a receiving cell has a control contour such that, when pressure is applied to the control contour along an insertion direction (R), the engagement finger pivots out of the through-opening.

4. The magazine as claimed in claim 1, wherein at least one insertion finger of the receiving cell is designed, as a result of pressure, to pivot outward toward the cell frame.

5. The magazine as claimed in claim 1, wherein two adjacent receiving cells of the magazine are connected together via a connecting portion, wherein the connecting portion has a lower spring constant than an adjoining receiving cell.

6. The magazine as claimed in claim 1, wherein the magazine has at least one connector which is designed for connecting to a further magazine.

7. The magazine as claimed in claim 1, wherein
the connector is in the form of a symmetric connector, or
the connector is in the form of an asymmetric connector, wherein the magazine has at least one female connector and at least one male connector that is congruent with the female connector.

8. The magazine as claimed in claim 5, wherein the connector has a latching mechanism or at least a partial latching mechanism.

9. The magazine as claimed in claim 1, wherein the magazine is made from a biodegradable material.

10. The magazine as claimed in claim 1, wherein the magazine is entirely biodegradable.

11. The magazine as claimed in claim 1, wherein the magazine is in the form of a strip.

12. The magazine as claimed in claim 1, wherein the receiving cell has at least one bending tab.

13. The magazine as claimed in claim 1, wherein at least one cutout has been made in the bending tab.

14. A filled magazine comprising a magazine as claimed in claim 1, and at least one fastening means having a collar, wherein, in the case of at least one of the fastening means, the collar of the fastening means is held by at least one engagement finger.

15. A method for setting the fastening means in a wall and/or a ceiling on a construction site, the method comprising setting the fastening means using a construction robot having a setting tool having the filled magazine of claim 14.

16. The magazine as claimed in claim 3, wherein when the pressure is applied, the engagement finger pivots out of the through-opening towards the cell frame.

17. The magazine as claimed in claim 2, wherein at least one engagement finger of a receiving cell has a control contour such that, when pressure is applied to the control contour along an insertion direction (R), the engagement finger pivots out of the through-opening.

18. The magazine as claimed in claim 2, wherein at least one insertion finger of the receiving cell is designed, as a result of pressure, to pivot outward toward the cell frame.

19. The magazine as claimed in claim 2, wherein two adjacent receiving cells of the magazine are connected together via a connecting portion, wherein the connecting portion has a lower spring constant than an adjoining receiving cell.

20. The magazine as claimed in claim 2, wherein the magazine has at least one connector which is designed for connecting to a further magazine.
